(19) United States
(12) Patent Application Publication
(10) Pub. No.: US 2002/0129362 A1
(43) Pub. Date: Sep. 12, 2002

(54) Multiple commercial option in the same time slot

(76) Inventors: Matthew S. Chang, San Diego, CA (US); Aditya Krishnan, San Diego, CA (US); Andrew M. Proehl, San Francisco, CA (US); David K. L. Yang, San Jose, CA (US); Frederick J. Zustak, Poway, CA (US); Peter Rae Shintani, San Diego, CA (US); Mark Kenneth Eyer, Kirkland, WA (US); Nicholas Colsey, Del Mar, CA (US); Brant L. Candelore, Escondido, CA (US); Dayan Ivy Golden, San Diego, CA (US)

Correspondence Address: William S. Frommer, Esq., FROMMER LAWRENCE & HAUG LLP, 745 Fifth Avenue, New York, NY, 10151, US

(21) Appl. No.: 09/801,582

(22) Filed: Mar. 8, 2001

(51) Int. Cl. H04N 7/025; H04N 7/10; G06F 3/00; H04N 5/445

(52) U.S. Cl. 725/32; 725/42; 725/38; 725/34

(57) ABSTRACT

A technique for displaying a television commercial on end user equipment includes providing a plurality of commercials available to be played on the end user equipment while tuned to a television channel, e.g., by pre-storing the audio/video of those commercials on a storage medium of the user equipment. The onset of a commercial time slot on the television channel is detected; and a selection is made, at the end user equipment, of one of the plurality of commercials. The selected commercial is played during the detected commercial slot as a substitute for the commercial broadcast on the television channel.

### BACKGROUND OF THE INVENTION

1. Field of the Invention

The present invention relates generally to interactive television systems.

2. Description of the Related Art

In recent years, interactive television systems have come of age, expanding the capabilities of modem day televisions. Television viewers may now order custom television programming on demand, surf the World Wide Web, and so forth, using the capabilities of their state of the art interactive television devices. With the advent of the set-top box the functionality of ordinary “dumb” televisions has expanded dramatically.

Despite the introduction of interactive television, the manner in which advertiser's messages have been delivered to television viewers' equipment has not changed from the traditional approach. In essence, the typical practice is to periodically interrupt nationally broadcast television programs with nationally broadcast commercial segments, and to broadcast the commercials of both national and local advertisers on locally broadcast programs. Naturally, the type of commercial shown is usually tailored to the type of television program being aired. For example, beer commercials are shown during sporting event programs, toy commercials are aired during cartoon programs, etc. Despite this practice, however, advertiser's messages often fall on deaf ears, as not all sports enthusiasts are beer drinkers; an adult cartoon lover may not be a toy shopper; and so forth.

Recently, set-top box type devices have been sold in the marketplace which are configured to eliminate commercials altogether at the user's option. While such devices may be enjoyable to end users, they diminish the reach of advertisers supporting the television programs. Ultimately, such commercial erasure systems may prove detrimental to the quality of televised programs as advertisers reduce funding for television advertising and turn to other media sources to convey their messages to consumers.

### OBJECTS AND SUMMARY OF THE INVENTION

Accordingly, it is an object of the present invention to provide a way to more efficiently tailor television commercials to viewers to heighten viewer interest in the commercials shown.

It is another object of the invention to provide an interactive television system that allows an end user to reduce the frequency of viewing undesirable commercials.

An additional object of the invention is to provide an interactive television system that allows an end user to select among a number of candidate commercials that may be shown.

In accordance with one aspect of the invention, a method for displaying a television commercial on end user equipment includes providing a plurality of commercials available to be played on the end user equipment while tuned to a television channel, e.g., by pre-storing the audio/video of those commercials on a storage medium of the user equipment. The onset of a commercial time slot on the television channel is detected; and a selection is made, at the end user equipment, of one of the plurality of commercials. The selected commercial is played during the detected commercial slot as a substitute for the commercial broadcast on the television channel.

The selection may be performed in a number of ways, such as by the end user dynamically selecting from among the plurality of commercials displayed in a picture-in-picture or other type of display. Other selection options include automatically selecting based on an established profile of the particular end user; or based on a prior selection history or viewing history of the end user.

The above and other objects, features and advantages according to the present invention will be apparent from the following detailed description of the illustrated embodiments when read in conjunction with the accompanying drawings.

### BRIEF DESCRIPTION OF THE DRAWINGS

The following detailed description, given by way of example and not intended to limit the invention solely thereto, will best be appreciated in conjunction with the accompanying drawings, in which like reference numerals denote like elements and parts, wherein:

FIG. 1 is a system block diagram of an interactive television system employing a set-top box;

FIG. 2 is a functional block diagram of a digital set-top box suitable for use with the present invention;

FIG. 3 is an illustrative data table stored within a user profile database provided to tailor commercials to an individual user;

FIG. 4 is a flow diagram illustrating an exemplary software routine for tailoring commercials to individual users in accordance with the invention;

FIG. 5 is a flow diagram illustrating a routine for enabling an end user to dynamically select and exclude commercials; and

FIG. 6 shows a picture-in-picture display that facilitates dynamic commercial selection by the end user.

### DETAILED DESCRIPTION OF PREFERRED EMBODIMENTS

Preferred embodiments of the present invention will now be described in the context of an interactive television system employing a set-top box. It is understood, however, that the invention is not limited to this application and may be embodied in other forms, as for example, a system employing interactive television electronics within a television itself.

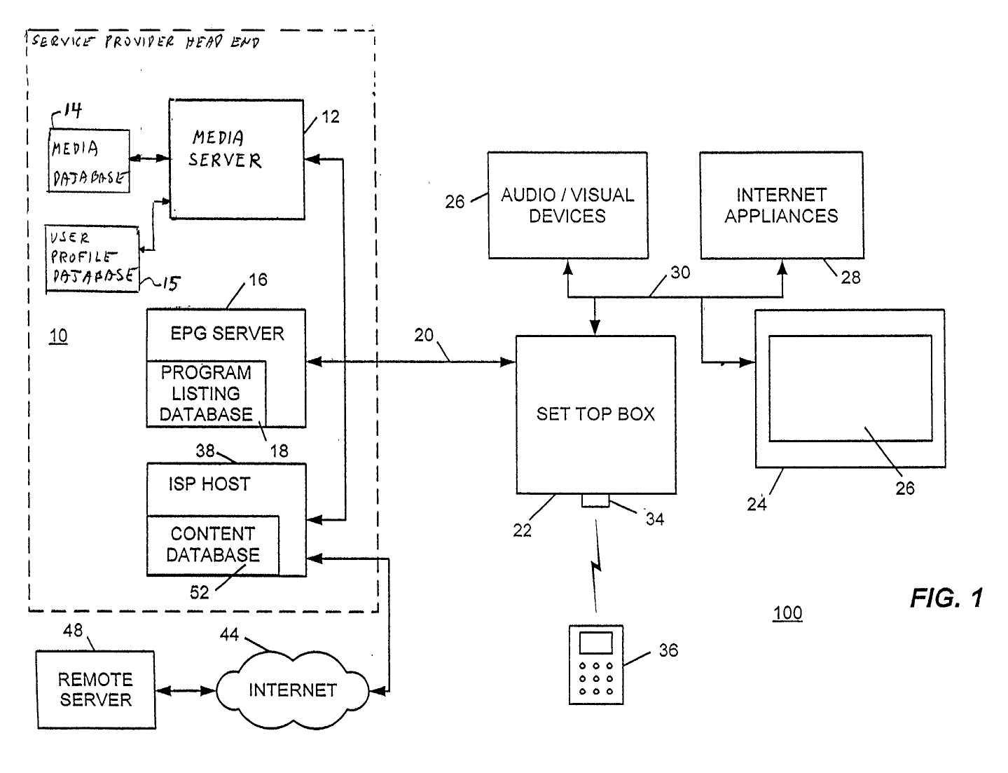

Referring to FIG. 1, a block diagram for an exemplary interactive cable or satellite television (TV) system 100 in accordance with the invention is shown. The system 100 includes, at a service provider head end 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. On the user side, a set-top box (STB) 22 can generally provide for bi-directional communication over a transmission medium 20 in the case of a cable STB 22. In other embodiments, bi-directional communication can be effected using asymmetrical communication techniques, e.g., using dual communication media—one for the uplink and one for the downlink. In any event, the STB 22 can have its own Universal Resource Locator (URL) assigned thereto to provide for addressability by the head end and users of the Internet.

Service provider head end 10 further includes an optional user profile database 15 which media server 12 consults to more efficiently tailor commercials to the individual end users. For instance, an end user who subscribes to the user profiling/commercial customization service may provide his or her profile information to the service provider in advance via questionnaires and the like. Such profile information may include age, gender, interests, etc., whereby the service provider can select the types of commercials most suitable for that particular user. The profile information may also include a history of commercial selections and/or exclusions made by the user, thereby further tailoring commercials to the viewer. User profiling techniques will be discussed in further detail later.

The media server 12 and EPG server 16 are coupled by transmission medium 20 to set top box (STB) 22. The transmission medium 20 can be, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB.

The exemplary system 100 further includes a TV 24, such as a digital television, having a display 26 for displaying programming, an EPG, etc. The STB 22 may be coupled to the TV 24 and various other audio/visual devices 26 and Internet Appliances 28 by an appropriate interface 30, which can be any suitable analog or digital interface. In one embodiment, interface 30 conforms to an interface standard such as the Institute of Electrical and Electronics Engineers (IEEE) 1394 standard. The STB 22 may include a central processing unit (CPU) and memory such as Random Access Memory (RAM), Read Only Memory (ROM), flash memory, mass storage such as a hard disc drive, floppy disc drive, optical disc drive or may accommodate other electronic storage media, etc. Such memory and storage media are suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g. using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

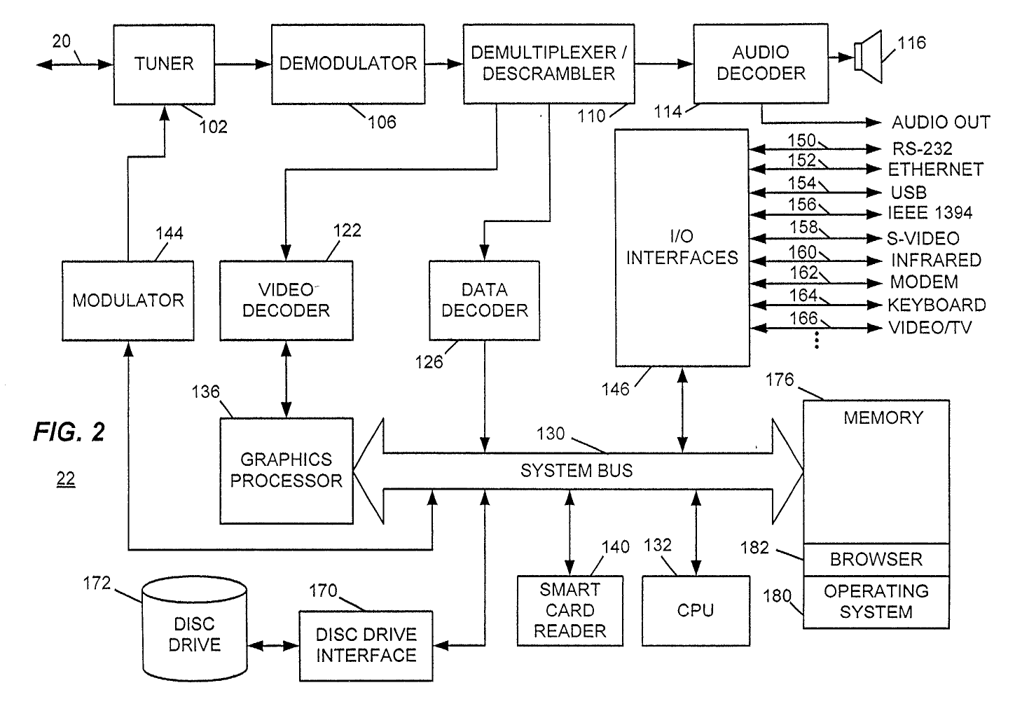

Referring now to FIG. 2, a typical system configuration for a digital set-top box 22 is illustrated. In this exemplary set-top box, the transmission medium 20, such as a coaxial cable, is coupled by a suitable interface to a tuner 102. Tuner 102 may, for example, include a broadcast in-band tuner for receiving content, an out-of-band (OOB) tuner for receiving data transmissions and a return path tuner for providing an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g. audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card”, often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the tuner (operating as a return path OOB tuner) and out through the transmission medium 20. This capability is used to provide a mechanism for the STB 22 and/or its user to send information to the head end (e.g. service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire® or i-link®) or IEEE 1394 wide port 156, S-video port 158 or infrared port 160. Such interfaces can be employed to interconnect the STB 22 with any of a variety of accessory devices such as storage devices, audio/visual devices 26, gaming devices (not shown), Internet appliances 28, etc.

I/O interfaces 146 can include a modem (be it dial-up, cable, DSL or other technology modem) having a modem port 162 to facilitate high speed or alternative access to the Internet or other data communication facility. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bi-directional communication via the DOCSIS cable modem with the STB 22 being identified by a unique URL (Universal Resource Locator).

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 to memory 176. Memory 176 may include a combination of any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention.

In general during operation of the STB 22, an appropriate operating system 180 such as Sony Corporation's Aperios™ real time operating system is loaded into, or is permanently stored in, active memory along with the appropriate drivers for communication with the various interfaces. Along with the operating system and associated drivers, the STB 22 usually operates using browser software 182 in active memory or permanently residing in ROM or EEPROM. The browser software 182 typically operates as the mechanism for viewing not only web pages on the Internet, but also for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all include at the lowest layer various hardware interface layers. Next is an operating system layer as previously described. The software architectures of modem STBs have generally evolved to include a next layer referred to as middleware. Such middleware permits applications to run on multiple platforms with little regard for the actual operating system in place. Middleware standards are still evolving at this writing, but are commonly based upon JavaScript and HTML (HyperText Markup Language) virtual machines. At the top layer is the application layer where user applications and the like reside (e.g. browsing, email, EPG, Video On Demand (VOD), rich multimedia applications, pay per view, etc). The current invention can be utilized with any suitable set-top box software architecture.

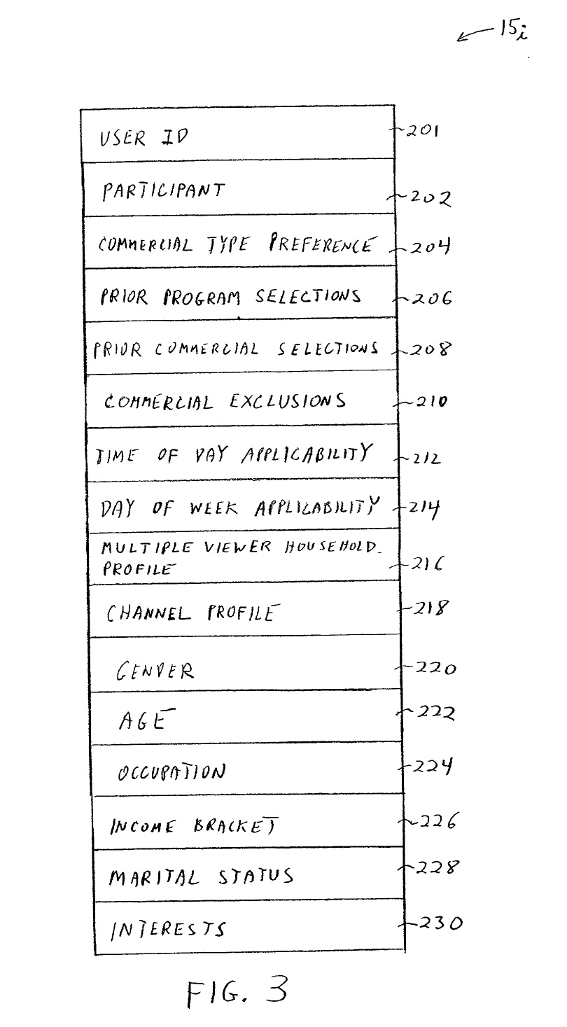

FIG. 3 shows an exemplary data table 15i occupying a portion of user profile database 15 stored at the service provider head end 10 (or at the set-top box 22). As explained previously, the provision of a user profile database 15 containing profile data for each individual user allows commercials to be customized for each user, thereby increasing advertising efficiency. During a broadcast, when the time for a commercial slot begins, system 100 will deliver a commercial to a particular end user in accordance with the information contained within table 15i, which is specifically allocated for that user. The items within the shown table 15i are merely exemplary of those that may be employed within a user profile database for the purpose of commercial customization.

Field 201 of table 15i contains user ID information corresponding to a specific end user. All the information in the subsequent fields 202-230 pertains to the specific user identified by the user ID. Field 202 is a “participant field” containing a code indicating whether or not the specific user is a participant in the user profiling system. It is possible that some users of the interactive television system may not wish to participate in the commercial customization service due to disinterest or other reasons. (To encourage participation, service providers may offer discount incentives or bonus services to users.) If the participation field 202 indicates a non-participant entry, the remaining fields in table 15i are null or non-existent for that user.

A “commercial type preference” field 204 contains preferred commercial types for the particular user. The preferences may be established in a number of ways. For instance, preferences may be selected by means of the user by filling out a written questionnaire or responding to on-line prompts when signing up for the service, etc. By way of example, a particular user may indicate preferences for beer and on-line shopping site commercials, and a non-preference (i.e., a commercial type to preferably avoid) for automobile commercials. The interactive television system 100 would then deliver a higher frequency of beer and on-line shopping ads than normal, and a lower frequency of car ads than normal to that particular user.

Alternatively or additionally, the commercial type preferences may be ascertained based on the user's program viewing history and/or dynamic commercial selection history. The users viewing history as well as any dynamic commercial selections and exclusions are documented and stored in fields 206 and 208 as factors to establish preferences. In a dynamic commercial selection process, to be described in further detail below, the user makes commercial choices in real time during actual commercial time slots, or during a commercial preview mode.

Field 210 is a commercial exclusion field, containing codes corresponding to commercials the user has specifically identified to be excluded from further airing on the user's television. The system may be configured such that each user is allowed to exclude up to a predetermined number of specific commercials from being shown. The mechanism by which a specific commercial can be excluded will be described below.

The end user may be given the option of participating in the user profiling and/or commercial customizing service only during certain days of the week or times of each day. Fields 212 and 214 respectively contain data for time of day and day of week applicability. For instance, a working adult user who has children watching television during the day may request profiling and specific commercial type delivery only during evening hours, or only on weekends, etc.

A more complex interactive television system takes into account multiple viewer household profile data stored in field 216 and/or channel profile data stored in field 218. Commercial customization could be applied to individual users of a multiple viewer household using common equipment in a number of ways. One technique entails storing a profile for each individual user of a household. A user could input his or her own user ID by an appropriate means (e.g., via keyboard) whenever using the system. In this case, the system would retrieve the relevant user profile and commercial preference data corresponding to that user ID. An alternative method is based on time of day or day of week; for instance, commercial preferences might be automatically set for User A's preferences during weekdays and for User B's preferences on the weekends.

The multiple viewer household problem could also be resolved, at least in part, in conjunction with the channel profile in field 218. That is, an assumption could be made that certain members of the household only watch specific channels (or specific programs). When specific channels are detected to be in use, the commercials aired during the commercial slots of those channels would be geared for the relevant user. For example, it may be assumed that only the children of a particular household view cartoon channels, and thus commercials would be delivered in accordance with the predetermined preferences for those particular children whenever tuning to the cartoon channels is detected. The decision could alternatively (or additionally) be program based—e.g., a predetermined code could be inserted into a broadcast program indicating whether the program is a cartoon program, soap opera, etc., and commercials delivered during those programs would be customized in accordance with pre-supplied multiple viewer household information. User-specific programs could also be identified by the individual users in the questionnaire phase. In this case, field 218 would be expanded to a program based profiling system.

Fields 220-230 delineate user-profile information such as the user's gender, age, occupation, income bracket, marital status and interests. This user-profile information can be used by the system software to generate commercial type preferences and non-preferences (i.e., commercial types to avoid) which are ultimately recorded in field 204. The commercial preferences established in this manner may be additive to those generated by the above-mentioned methods (e.g., based on questionnaires, dynamic user selection, etc).

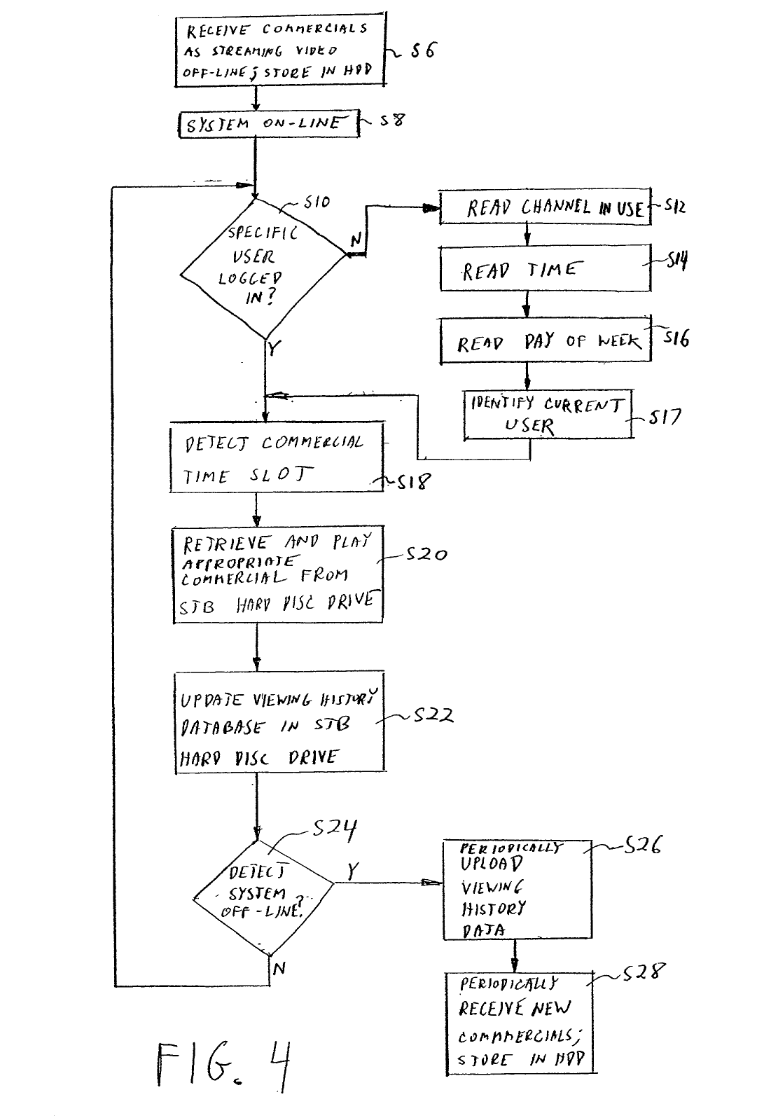

FIG. 4 is a flowchart depicting an exemplary routine for delivering customized commercials to end users of the interactive television system 100. In step S6, the system is off-line (i.e., the end user's television equipment is detected to be off) and the service provider head end 10 transmits commercials as streaming video to the user set-top box 22 for storage in its hard disk drive (HDD) 172 or other storage medium (e.g., DVD, CD, flash memory, EEPROM, floppy disc, etc). At this point, the commercials delivered may or may not already be customized for the particular end user(s). That is, depending on the system configuration, software running on media server 12 could implement the customization beforehand by consulting the information stored within user profile database 15, and selecting appropriate commercials from media database 14. On the other hand, the bulk of the customization process could alternatively be performed by software running in set-top box 22, in which case a larger volume of commercial data would be delivered off-line from head end 10.

In step S8, it is determined that the end user equipment is turned on, i.e., the user's television is detected to be on (as detected by set-top box 22) or the user is attempting to log onto the system using a keyboard connected to the relevant set top box I/O port. Next, in step S10, it is determined whether a specific user is logged in. As explained above, in a multiple user household, individual users are given the option of logging in, thereby allowing commercials to be tailored for each individual user of the household. If in step S10 a user is not logged in, the flow proceeds to steps S12-S16 where the system reads the detected channel in use, and the current time and day of week from an internal clock. As discussed earlier, television users in a multiple user household may be identified from time of day, day of week, or channel in use information recorded in data table 15i. In step S17 the system identifies the current user based upon the information read in steps S12-S16. Naturally, if no multiple viewer household provisions have been made, the current user will simply be identified in step S17 as the normal end user who is signed up for the commercial customization service.

In any case, once the current user is identified, a predetermined number of commercials tailored for that user are initially loaded from the HDD 172 into active memory 176 (see FIG. 2) to enable the rapid delivery of a commercial during the next commercial time slot. In the case where no user profiling has been performed, but the user still has dynamic selection options (to be discussed below), default commercials are loaded into the buffer. A pricing model is preferably implemented which charges advertisers more if their commercials are shown during the default mode.

Next, in step S18 the CPU 132 of set top box 22 detects the onset of a commercial time slot on the channel to which the user equipment is tuned. In this example, since custom commercials are retrieved from the hard disk drive, the set-top box needs to employ a suitable means to detect the onset of a commercial broadcast from the service provider head end. This can be accomplished by software running on CPU 132 dynamically detecting the presence of predetermined codes inserted in the broadcast on the television channel to which the set-top box is currently tuned. Predetermined codes can be designated as indications for, e.g.: the imminent commencement of a commercial time slot (or the commencement of a commercial time slot from a specific time from the occurrence of the code in the broadcast); and the precise duration of the upcoming commercial slot. When the onset of a commercial time slot is so detected, the next commercial waiting in buffer memory 176 is output for viewing as a substitute for the commercial broadcast on the television channel to which the system is tuned. A subsequent commercial to be shown thereafter is then transferred from the hard disc drive to buffer memory 176. Each time a specific commercial is shown, this fact is recorded by updating a commercial viewing history database stored on HDD 172 in step S22. In addition, program and channel viewing history is preferably monitored and recorded as well on HDD 172.

In step S24, if the system has returned to the off-line state, commercial and program/channel viewing history data can be uploaded in step S26 to head end 10 for storage in user profile database 15. Head end 10 analyzes the updated user profile information to determine whether or not commercial preferences should be changed for the user. When changes are made, new commercials in accordance with the changes are downloaded to set-top box 22. In general, head end 10 periodically downloads new commercials to STB 22 in step S28, and transmits instructions as to whether any commercials currently stored within STB 22 should be erased. Note that it is also possible for the new commercials and instructions to be transmitted to STB 22 in an on-line state as well as the off-line state. In addition, the analysis necessary to define commercial preferences in the first place based on the user-supplied profile, and to update the preferences based on viewing history and so forth can be performed by software running in STB 22 rather than in head end 10. In either case, STB 22 uploads commercial viewing history to head end 10 so as to enable the head end to charge advertisers in accordance with the frequency of commercials viewed.

In an alternative embodiment of the invention, instead of storing commercials in the hard disk drive of the user's set top box, all the commercials are delivered in real time directly from media server 12 of head end 10. In this case, the above described steps S10 to S22 are performed by software at head end 10 rather than at the set top box.

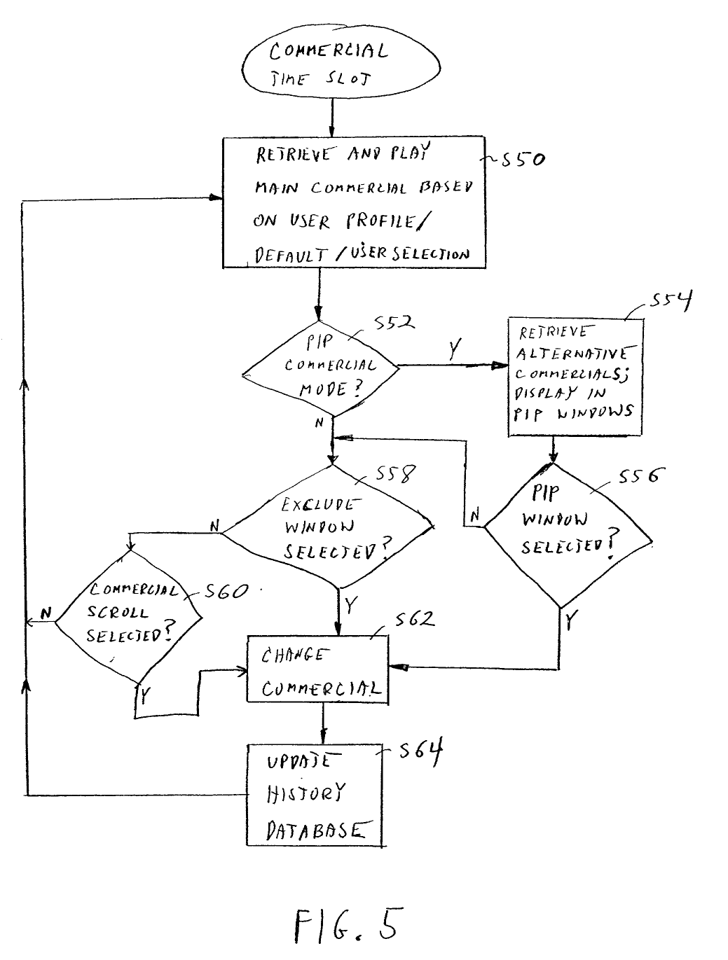

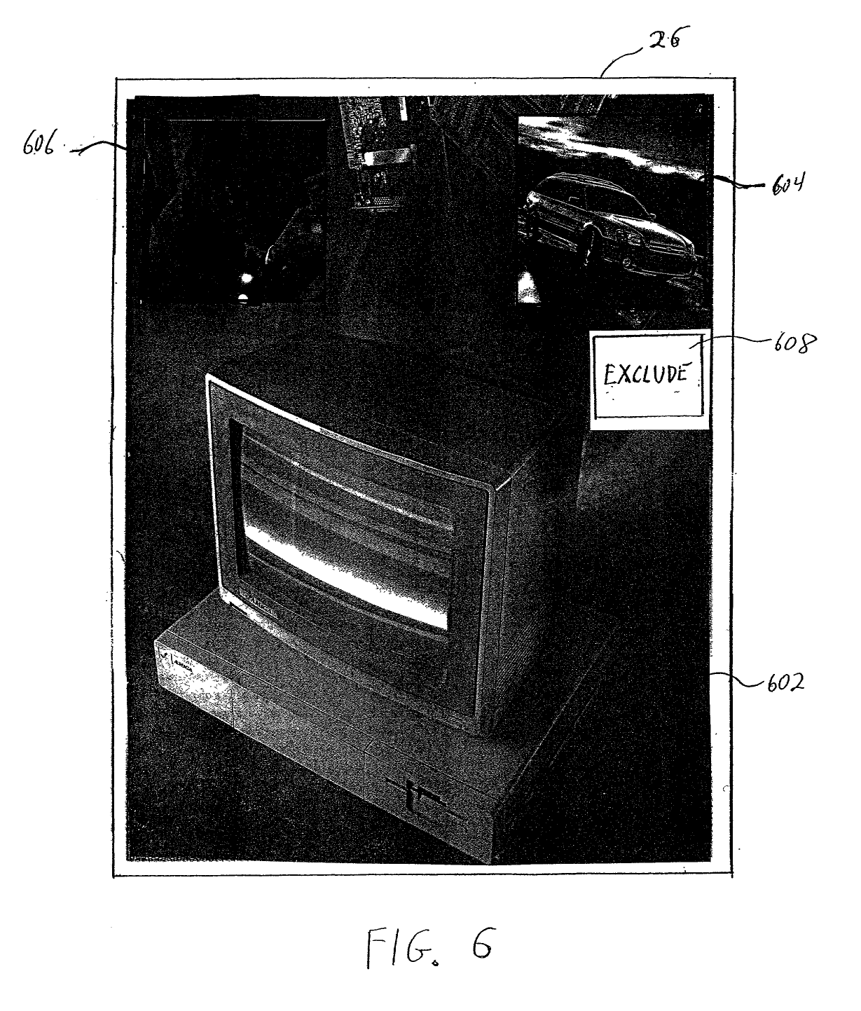

FIG. 5 is a flow diagram depicting a dynamic commercial selection procedure in accordance with the invention which allows the user to select between commercials during a commercial time slot, without changing the television channel. The process also allows users to select a predetermined number of commercials for future elimination, i.e., to never be shown again to the current user (unless subsequently de-selected for elimination). As in the case of the routine of FIG. 4, the steps in the routine of FIG. 5 can be performed either by software running on the CPU 132 of set top box 22, or remotely at head end 10. When the time for a commercial time slot begins, the system retrieves and plays a main commercial based on either the end user profile in database 15 as discussed previously, or, if no profile exists, a default commercial is played. The commercial to be shown at this time might also be one pre-selected by the user in a commercial preview mode. In either case, once a commercial is playing, the user has the option to change it to an alternative commercial while the system remains tuned to the current channel. The option may be presented to the user in a picture-in-picture (PIP) mode, as illustrated in FIG. 6. Main commercial 602 plays with corresponding audio, whereas alternative commercials 604, 606 superimposed in smaller windows with the main commercial play without sound. An “EXCLUDE” window 608 is also superimposed with the main commercial. The Exclude window may be provided whether or not the other PIP windows 604,606 are displayed.

With continuing reference to FIG. 5, if a PIP commercial mode is determined to exist in step S52, the system retrieves alternative commercials as 604, 606 and simultaneously displays these in PIP windows along with the main commercial (step S54). In step S56 it is determined if any of the PIP windows are selected. An alternative commercial may be selected by a conventional means, such as by the user highlighting one of the PIP windows using the left, right, up or down arrow keys of a remote controller, where each stroke of an arrow key results in a different window being highlighted. Then, by pressing an Enter key or the like on the remote controller while a PIP window is highlighted, the highlighted window is selected and the main commercial is changed in step S62 to the selected commercial (i.e., the selected commercial is displayed on the entire screen). The PIP windows may be caused to disappear at this point. The system can also be designed such that if no PIP window is selected within a predetermined time, such as 10 seconds, the PIP windows disappear.

If the EXCLUDE window 608 is selected in step S58, the main commercial is de-selected and changed in step S62 to a different one, such as one of the alternative commercials in the PIP windows. When this occurs, the system flags the main commercial selected for exclusion as an excluded commercial that is not to be shown again to the current user. The history database is updated in step S64 to reflect this event, or to record the other selections made in steps S56 or S60 (if any). Each user may be allowed a predetermined number of specific commercial exclusions.

The dynamic selection of commercials need not be made using the PIP mode. For example, commercials can be selected using a scrolling method (steps S60 and S62) in which only one commercial at a time is displayed, but can be switched to another by means of the user manipulating a scrolling key on a remote controller or the like. Selections made with the scrolling technique are likewise recorded in a history database in step S64. In any case, whether user selections are made with the use of the PIP mode or an alternative mode, when the duration of the broadcast commercials within the detected time slot is complete (as known, for example, from the CPU 132 detection of a predetermined code in the television channel broadcast), the system terminates displaying audio/video retrieved from the HDD, and returns to displaying the actual program broadcast on the television channel in real time.

Although preferred embodiments of the present invention and modifications thereof have been described in detail herein, it is to be understood that this invention is not limited to these embodiments and modifications, and that other modifications and variations may be effected by one skilled in the art without departing from the spirit and scope of the invention as defined by the appended claims.

What is claimed is:

1. A method for displaying a television commercial on end user equipment, comprising the steps of:
providing a plurality of commercials available to be played on said end user equipment while said equipment is tuned to a television channel;
detecting the onset of a commercial time slot on said television channel;
selecting, at said end user equipment, one of said plurality of commercials; and
playing said selected one of said plurality of commercials on a display during said detected commercial slot as a substitute for a commercial broadcast on said television channel, while said end user equipment remains tuned to said television channel.

2. The method of claim 1, wherein said selecting step is performed by an end user selecting among said plurality of commercials.

3. The method of claim 2, further including simultaneously displaying at least two of said commercials, each on a respective portion of said display, wherein said selecting step is performed by the end user selecting one of the displayed commercials.

4. The method of claim 1, further comprising customizing said plurality of commercials for a particular end user.

5. The method of claim 1, wherein said one commercial is selected based upon a user profile.

6. The method of claim 1, wherein said one commercial is selected based at least upon a prior viewing history of an end user.

7. The method of claim 1, wherein said one commercial is selected based at least upon a prior commercial selection history of an end user.

8. The method of claim 1, wherein said plurality of commercials are pre-stored on a storage medium at an end user location.

9. The method of claim 8, wherein said storage medium is located in a set-top box.

10. The method of claim 9, wherein said storage medium is a hard disc drive.

11. The method of claim 8, wherein said storage medium is selected from the group consisting of a hard disc drive, a DVD, a CD, flash memory, EEPROM and a floppy disc.

12. The method of claim 8, further comprising periodically replacing said plurality of commercials stored on the storage medium.

13. The method of claim 1, wherein said plurality of commercials are stored at a remote location, and are transmitted to the end user equipment to be played thereat.

14. The method of claim 1, wherein said selecting step is performed by an end user selecting among said plurality of commercials to be excluded from further viewing, such that a substitute commercial is played as said selected commercial immediately following the exclusion selection, and further comprising storing information identifying the commercial selected to be excluded.

15. The method of claim 1, further comprising storing information pertaining to the number of times a particular commercial has been played at a particular user's equipment, and charging an advertiser in accordance with the number of plays.

16. Apparatus for displaying a television commercial on end user equipment having a television receiver, comprising:
a storage device for storing a plurality of commercials received by said user equipment;
a detecting device for detecting the onset of a commercial slot on a broadcast of a television channel to which the television receiver is tuned; and,
a selector for selecting one of said plurality of commercials stored on said storage device to be displayed on said user equipment during said detected commercial time slot as a substitute for a commercial broadcast on said television channel, while said television receiver remains tuned to said television channel.

17. The apparatus of claim 16, further comprising means for receiving a user input for selecting said one commercial.

18. The apparatus of claim 17, further including means for simultaneously displaying at least two of said commercials, each on a respective portion of a display of said user equipment, and for receiving said user input as a selection of one of said simultaneously displayed commercials.

19. The apparatus of claim 16, further comprising means for automatically selecting said one commercial based upon at least one of a user profile and default information.

20. The apparatus of claim 19, further comprising means for updating a user profile based on commercial selections made by the end user.
